(19) United States
(12) Patent Application Publication
(10) Pub. No.: US 2017/0344923 A1
(43) Pub. Date: Nov. 30, 2017

(54) Personal Life Manager (PLM) System and Method

(71) Applicant: FILLMORE WEST INVESTMENT TRUST, Jacksonville, FL (US)

(72) Inventors: Chad R. Pike, Crested Butte, CO (US); Austin Lowery, Mill Valley, CA (US); Jeffrey Skonieczny, Sarasota, FL (US); John Featherman, Crested Butte, CO (US); Thomas Babcock, New York, NY (US); Gray Camp, Jacksonville, FL (US)

(21) Appl. No.: 15/112,035

(22) PCT Filed: Feb. 2, 2016
(86) PCT No.: PCT/US16/16130

§ 371 Date: Jul. 15, 2016

Related U.S. Application Data
(60) Provisional application No. 62/110,734, filed on Feb. 2, 2015.

(51) Int. Cl. G06Q 10/06; G06Q 10/10; H04L 12/28; G06F 3/0482; G06Q 40/00

(52) U.S. Cl. CPC G06Q 10/06312; H04L 12/2803; G06F 3/0482; G06Q 10/10; G06Q 40/00

(57) ABSTRACT

A system and method perform personal life management (PLM). A three-dimensional filtering method in combination with an interface performs three types of selectable filtering criteria: an application type, an asset or asset class, and contextual filter corresponding to a selected application type and/or asset or asset class. Summaries of data, operation, and notification entry points are displayed for use by a user in accordance with selected application, asset, and contextual filters. Available applications include property management applications enabling remote access and control of systems installed on a premises, as well as management of personal property, tangible assets, intangible assets and financial assets. An application enabling valuation and control of complex financial assets is also disclosed as part of the PLM application.

### CROSS REFERENCE TO RELATED APPLICATIONS

This application is a national stage application of International Application No. PCT/US16/16130, filed on Feb. 2, 2016, which claims priority to U.S. Provisional Application No. 62/110,734, filed on Feb. 2, 2015, both of which are incorporated by reference.

### BACKGROUND OF THE INVENTION

### 1. Field of the Invention

The present invention relates to a personal life manager, and in particular to a system and method which facilitate all aspects of managing one's personal life.

### 2. Description of Prior Art

A lifetime of work and careful planning or a successful business can lead to an individual having a large number of professional activities and assets to manage. Professionals may be hired to assist; however, conscientious individuals may still desire to exercise oversight and personal control over their assets and professional activities. Software applications exist to manage some individual aspects of an individual's life, such as calendaring and project management software. However, each of such applications may come from different vendors and require familiarization with different interfaces. Inputting data required to enable the applications to perform their function can also be tedious.

### OBJECTS AND SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems and methods are disclosed herein providing inventive means for managing tasks and information relating to the management of multiple properties of multiple types in addition to other aspects of an individual's professional and personal life.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic block diagram of a computer system;

FIG. 2 is a schematic block diagram of a distributed computing environment suitable for use in accordance with an embodiment of the present invention;

FIG. 3 is an illustration of a dashboard interface in accordance with an embodiment of the present invention;

FIG. 4 is a process flow diagram of a method for providing interaction with a dashboard interface in accordance with an embodiment of the present invention;

FIG. 5 is an illustration of an interface to a personal life management (PLM) application in accordance with an embodiment of the present invention;

FIG. 6 is an illustration of an interactive floorplan for a lighting control system of a PLM application in accordance with an embodiment of the present invention;

FIG. 7 is an illustration of an interface for a lighting control system of a PLM application in accordance with an embodiment of the present invention;

FIG. 8 is an illustration for an interface to a security camera control system of a PLM application in accordance with an embodiment of the present invention;

FIG. 9 is an illustration of an interactive floorplan for a climate control system of a PLM application in accordance with an embodiment of the present invention;

FIG. 10 is an illustration of an interactive floorplan for an audio control system of a PLM application in accordance with an embodiment of the present invention;

FIG. 11 is an illustration of an interface to a map application of a PLM application in accordance with an embodiment of the present invention;

FIG. 12 is a process flow diagram of a method for performing remote property management using a PLM application in accordance with an embodiment of the present invention;

FIG. 13 is a process flow diagram of a method for managing energy usage using a PLM application in accordance with an embodiment of the present invention;

FIG. 14 is a process flow diagram for presenting geographically referenced information using a PLM application in accordance with an embodiment of the present invention;

FIG. 15 is a process flow diagram of a method for performing scheduled tasks using a PLM application in accordance with an embodiment of the present invention;

FIG. 16 is a process flow diagram of a method for valuing properties using a PLM application in accordance with an embodiment of the present invention;

FIG. 17 is a process flow diagram of a method for valuing financial assets and investments using a PLM application in accordance with an embodiment of the present invention;

FIG. 18 is a process flow diagram of a method for creating and managing notifications in accordance with an embodiment of the present invention; and

FIG. 19 is a process flow diagram of a method for navigating financial information in a complex investment or business entity in accordance with the embodiment of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE PREFERRED EMBODIMENTS

Certain terminology is used in the following description for convenience only and is not limiting. The article “a” is intended to include one or more items, and where only one item is intended the term “one” or similar language is used. Additionally, to assist in the description of the present invention, words such as top, bottom, upper, lower, front, rear, inner, outer, right and left are used to describe the accompanying figures. The terminology includes the words above specifically mentioned, derivatives thereof, and words of similar import.

The following description relates to a personal life management (PLM) application for enabling an individual to control and monitor various assets of various types in a convenient and intuitive manner. Tools for managing other aspects of an individual's private and professional life may also be integrated in the PLM application.

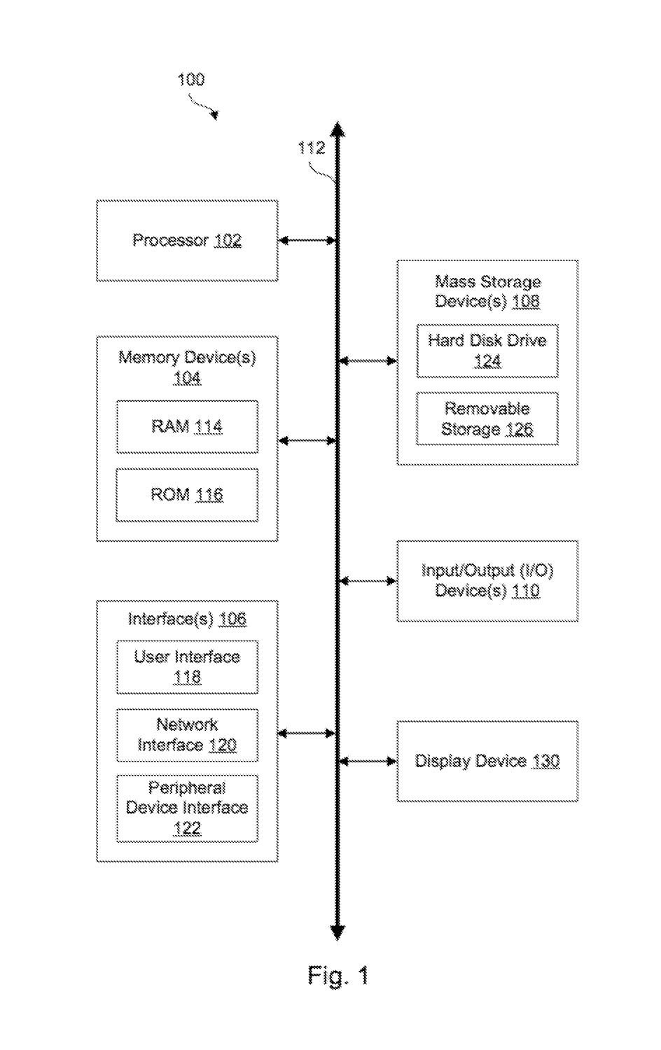

FIG. 1 is a block diagram illustrating an example computing device 100. Computing device 100 may be used to perform various procedures, such as those discussed herein with respect to a PLM application or local control system of a building. Computing device 100 can function as a server, a client, or any other computing entity. Computing device 100 can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer, smart phone, and the like.

Computing device 100 may include one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

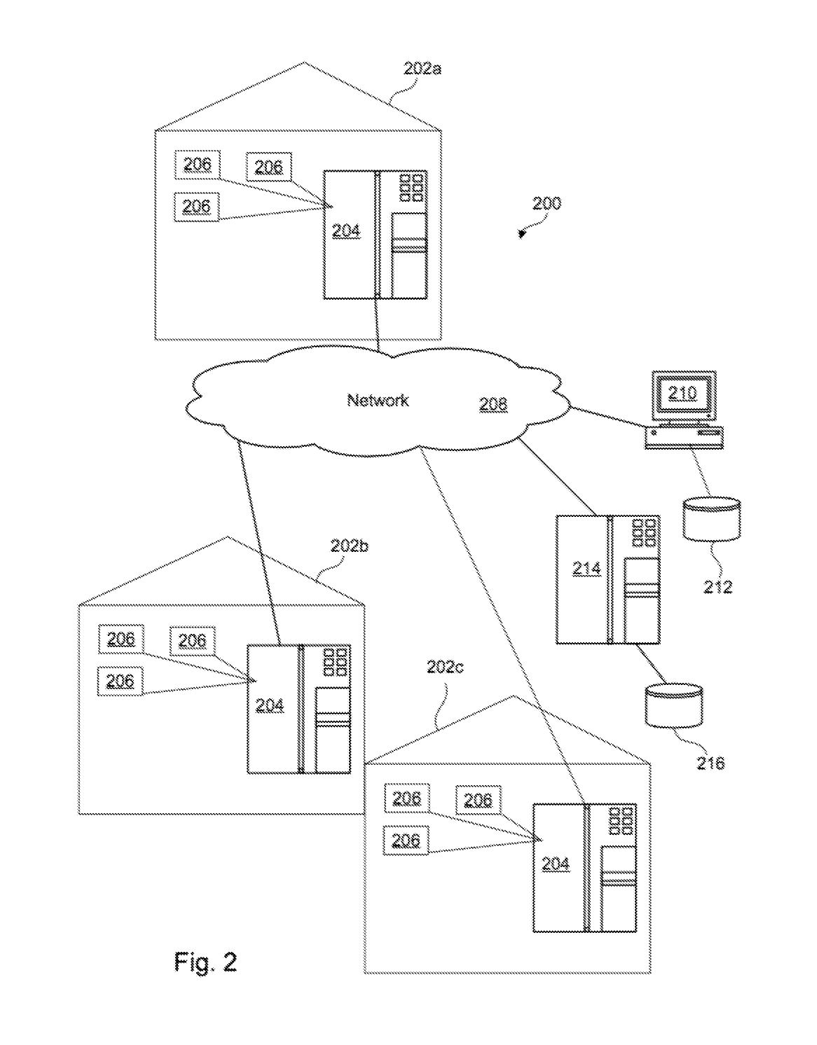

FIG. 2 is a block diagram illustrating an example operating environment 200 suitable for use in accordance with an embodiment of the present invention. The environment 200 may include one or more distributed properties 202a-202c associated with an entity. The properties 202a-202c may include residences, business premises, or other structures. The properties 202a-202c may be remote from one another, e.g., many miles away. The properties 202a-202c may include one or more control systems 204 for controlling one or more components 206 of the property. The components 206 may include lighting, audio and video, access controls, pool/spa controls, security systems, surveillance cameras, climate controls, televisions, projectors, shading systems, various types of sensors, and the like. Each of the components 206 may be coupled to the control system 204 by cabling or wirelessly. Alternatively, the components 206 may be standalone components that do not interact with a central control system 204. The control systems 204 may be operably connected to a network 208, such as the Internet and/or one or more local area networks (LAN). Individual components 206 may also be coupled directly to the network 208 rather than to a control system 204.

An owning or managing entity may interact with the remote control systems 204 and/or components 206 by means of a computing device 210. The computing device 210 may be a desktop or laptop computer, smart phone, tablet computer, or the like. The computing device 210 may include, or be operably securely coupled to, a database 212 containing records describing some or all of the properties 202a-202c and the components 206. The database 212 may be updated automatically by means of communication with the control systems 204 or components 206 using the network 208. Alternatively, the contents of the database 212 may be assembled by an operator and stored in the database 212.

The network 208 may also be securely coupled to one or more servers 214 that are in turn securely coupled to one or more databases 216. The servers 214 may be associated with a financial institution or other asset management institution and the databases 216 may contain records of financial and other intangible assets belonging to an owning or managing entity. The servers 214 may also be associated with other institutions or services and databases 216 that contain other information made available in the PLM; for example, information on weather, tides, snow conditions, digital rights management-protected content, genealogy services, and the like. The computing device 210 may communicate with the one or more servers 214 by means of the network 208. The control system 204, computing device 210, and server 214 may include some or all of the attributes of the computing device 100.

The operating environment 200 may be operable to perform functions of a personal life manager (PLM) in accordance with embodiments of the present invention. PLM is a software tool particularly useful for ultra-high net worth (UHNW) clients to help them manage and organize their complex lives. From a graphically rich dashboard the UHNW client can view their total net worth, can view all of their secure files and media, can manage and control any of their properties remotely, and perform other similar tasks.

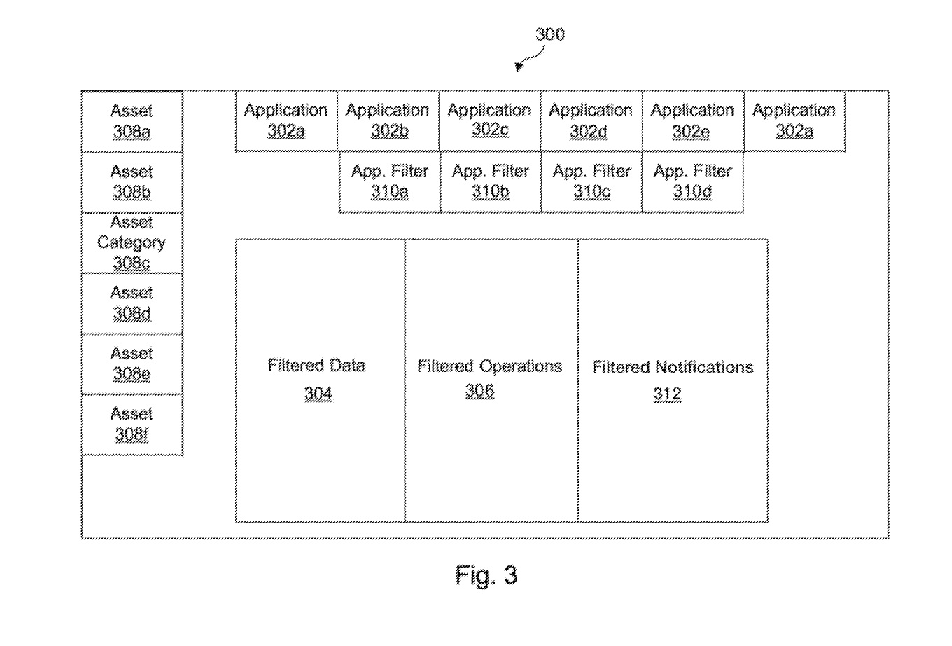

Referring to FIG. 3, a PLM dashboard 300 contains application widgets that plug into a PLM framework. The framework consists of entry points 302a-302f for various interfaces. For purposes of this disclosure an entry point is a graphical user interface element or other instruction that a user may use to invoke another interface or function. An entry point 302 may be a hypertext link, menu item, button, keyboard input, or the like.

FIG. 3 illustrates a dashboard 300 for performing a “three-dimensional” filtering of data and entry points in accordance with an embodiment of the present invention. As illustrated, the dashboard 300 may include a plurality of application entry points 302a-302f. The application entry points 302a-302f are selected by a user to invoke applications for presenting information relating to a user's assets, professional, and personal life. The application entry points 302a-302f may also be selected by a user to invoke the display of data relating to the application associated with the entry point 302a-302f. In this sense the application entry points 302a-302f operate as data filters controlling data 304 displayed in the dashboard 300. The data 304 may include summaries of data relating to aspects of the asset controlled by a selected application entry point 302a-302f. For entry points 302a-302f not related to managing an asset, data displayed may include summaries, or complete sets, of data operated on using the associated application. The application entry points 302a-302f also operate as filters for the operation entry points 306 and notification entry points 312 displayed on the dashboard. The operation entry points 306 may include user interface elements for invoking the functionality of the selected application. The functionality may include any of the functions described herein for managing or controlling aspects of a property or functions associated with other applications disclosed herein. The notification entry points 312 may include user interface elements for monitoring and managing notifications relating to entities within the system including data elements, operational elements, documents, photos, and the like.

The dashboard 300 may further include asset entry points 308a-308f. “Asset” as used herein may be any tangible or intangible asset, including real and personal property, financial assets, financial accounts, investments, investment accounts, services, and anything that can be the subject of a purchase, sale, or other type of transfer or exchange. The asset entry points 308a-308f may be selected by a user to invoke the display of data 304 relating to a selected asset or category of assets. The category of assets may be a geographic unit such as a country, state, or continent. The category of assets may be a class or type of asset such as real, personal, financial, and the like. Selection of an asset entry point 308a-308f filters the data 304, operation 306 and notification entry points 312 displayed in the dashboard to those relevant to the selected asset or category of assets. Where an application entry point 302a-302f has been selected, the data 304, operation 306, and notification entry points 312 displayed may be those selected according to both filtering criteria.

A third “dimension” of filtering may be provided by one or more contextual application filters 310a-310d. The contextual application filters 310a-310d may be selected according to the selection of an application entry point 302a-302f and/or the selection of an asset entry point 308a-308f. The contextual application filters 310a-310d may be operable to further filter the data 304, operation 306, and notification entry points 312 displayed in the dashboard 300 upon selection of one of the contextual application filters 310a-310d.

The application entry points 302a-302f may be linked to application interfaces for mail, messaging, task management, calendaring, document management, property management, asset management, financial management and the like, or asset interfaces for things like properties, businesses, accounts, material items and the like. Upon selection of some entry point 302a-302f, sub-entry points for components of the interface may be displayed. Examples of applications and other functions that may be performed using a dashboard 300 are illustrated hereinbelow.

### Property Management

A property management application may include security controls, audio system controls, surveillance camera feeds and controls, access controls, climate controls, pool and spa controls, lighting controls, energy monitoring, and the like. The property management application provided in association with the dashboard may interface with control systems 204 at a specific property 202a-202c. The control systems 204 at each local property 202a-202c may include a processor, wall-mounted touch panels or wireless control panels, keypads and remotes. Interfacing to a selected one or more control systems 204 from a remote application like the PLM application described herein enables a user to generate and communicate control signals to the one or more control systems 204 to remotely control multiple properties 202a-202c from a single computing device 210. For example, a property manager or owner may remotely prepare a residence for occupancy prior to arrival of the owner or a guest, such as by adjusting the internal temperature, turning on lights, opening doors, heating a pool or spa, and the like.

Audio and video system controls interfaced with a control system 204 may be accessed by the dashboard 300 to determine the status of audio and visual components of a remote property 202a-202c and adjust the content, volume, and other aspects of an audio/visual system or to turn it on or off.

Lighting system controls interfaced with a control system 204 may be remotely accessed by the dashboard 300 to enable a user to view the status of lights at a property, turn lights on or off, adjust the intensity of lights, activate particular lighting scenes, or control individual lighting circuits. The lighting system and/or dashboard 300 may define global scenes such as “house on” and “entertain” to allow a user to quickly and easily recall whole house lighting presets.

A surveillance system including several cameras may interface with a control system 204 and be remotely accessed using the dashboard 300. The cameras may be static or may include adjustable pan, tilt, and zoom (PTZ) capabilities. The dashboard 300 may interface with the control system 204 to obtain past or current video or still image content from the cameras. The dashboard 300 may also interface with a remote control system 204 to adjust the PTZ parameters of a particular camera.

A security system including sensors, alarms, smoke sensors, and the like may interface with a control system 204 and be remotely accessed using the dashboard 300. The dashboard 300 may enable a user to view the status of a security system and particular zones of a security system by interfacing with the control system 204. The dashboard 300 may also enable a user to remotely disable or reset the security system. For example, the dashboard 300 may present a floorplan view of a property 202 with visual indicators providing the status of doors, windows and motion sensors. If a door, window or motion is tripped a red “X” mark will appear over that area. If the area is secure a green check mark may be displayed.

An access control system may interface with a control system 204 and be remotely accessed by the dashboard 300 in order to allow a user to view the current status of doors and to remotely lock or unlock doors. The dashboard 300 may also interface with the control system 204 to obtain a log of persons who have accessed or attempted to access the property 202a-202c, such as by means of an access badge or other device. In some embodiments, the log may record a brief video clip (e.g. 10 seconds) recorded at an entry at the time of an attempt to enter to enable identification of the person attempting to gain access. This may be particularly advantageous for commercial properties with many employees. The dashboard 300 may also interface with the control system 204 to administer access privileges to individual users and enable an operator to add users, edit their access privileges or delete them from access control lists. The dashboard 300 may also interface with the control system 204 to update keypad or other access codes for a property 202.

A climate control system may interface with a control system 204 and be remotely accessed by the dashboard 300. The dashboard 300 may enable a user to remotely access the status of different climate zones and make adjustments. For example, the temperature of a property may be remotely adjusted to prepare for the arrival of an owner or guest. The dashboard 300 may also interface with the control system 204 to change climate presets so that an entire property 202 may be set to a designated climate level according to a departure/arrival schedule.

A pool control system may interface with a control system 204 and be remotely accessed by the dashboard 300 to manage the temperature of a pool or spa. For example, the temperature of a pool or spa may be adjusted by means of the dashboard 300 in anticipation of the arrival of an occupant to a property 202.

### Weather

The dashboard 300 may also access weather information in the vicinity of a property 202 and display the information adjacent controls for interface with the control system 204 of the property 202a-202c. The weather information may be obtained from weather monitoring equipment at the property or from information provided by a weather monitoring service or entity.

### Energy Management

The dashboard 300 may include an energy management module that allows a user to see current and historical energy consumption levels for each property 202a-202c. For example, the dashboard 300 may provide a bar chart showing data for the last hour, day, week, month and year in order to raise awareness of energy usage and help the user to understand their energy consumption habits in an effort to change those habits. Energy usage may be obtained from third party monitoring devices using current sensors for electricity and flow meters for water and gas. The energy management module may interface with a control system 204 to implement the settings of lighting system, climate control, and other components to implement a desired level of energy usage.

The above described functionality of the PLM dashboard 300 may be implemented by the interfaces associated with the entry points 302a-302f. The interfaces may be executed and installed by a user's computing device 212 or may be provided on a remote server and accessed by a browser or other client program executing on the computing device 212, i.e., a software as a service (SaaS) approach. The dashboard 300 may enable a user to control access privileges to the interfaces of the dashboard 300.

A status indicator for the interface associated with an entry point 302a-302f may be displayed on the dashboard 300 adjacent the entry point 302a-302f. For example, the status indicator for an audio/video entry point 302a-302f may indicate the number of active audio/video zones. The status indicator for a lighting system entry point 302a-302f may indicate the number of active lighting circuits. The status indicator 306 for a shading system entry point 302 may indicate the overall shade status of a property 202a-202c. The status indicator for a surveillance video entry point 302-302f may indicate a time stamp of the last video captured by a camera. The status indicator for a security system entry point 302a-302f may indicate the status of the security system and event feedback. The status indicator for an access control system entry point 302a-302f may indicate the last time someone entered a property 202. The status indicator for a climate control entry point 302a-302f may indicate the current temperature or current climate preset. The status indicator for a pool control entry point 302a-302f may indicate current pool and/or spa temperatures. The status indicator for a weather entry point 302a-302f may indicate the current weather at a property 202. The status indicator for an energy management module entry point may indicate the current kilowatt energy use. A status indicator may also be provided for the overall operational status of the control system 204 and the dashboard 300 itself. For example, a green dot may indicate proper functioning, a yellow dot may indicate a problem, and a red dot may indicate that the system is down or non-responsive.

### Maintenance and Issue Management

The dashboard 300 may include a maintenance module that allows a user to see the status of all maintenance and guest preparation checklists as well as maintenance and other issues to resolve for each property 202a-202c. For example, the dashboard 300 may provide a summary of the status of all checklists that have been assigned for completion. This may include the percentage complete for each outstanding checklist and an indicator of whether the checklist is being completed in a timely manner. A user may view a checklist to see specifics of what has been completed. The dashboard 300 may also provide a summary of the status of any issues identified for the property. A user may view an issue to see details about it, and may also resolve the issue. Users may also create checklists for each property 202a-202c, and may assign checklists to other users for completion. Also, users may create issues for a property 202a-202c and may assign issues to other users for resolution.

### Personal Financial Manager (PFM)

In some embodiments, the dashboard 300 includes an entry point 302a-302c for a personal financial manager (PFM) application. A user may own a wide variety of both real and intangible assets. The PFM may enable a user to track assets including but not limited to real properties, investments, various types of financial accounts, and other asset types in order to calculate and report the user's total net worth.

The PFM may also track cash flow, profits, and losses across property and business assets by allowing property and business managers to actively manage budgets and actuals. A hedge fund manager or other investment manager may use the PFM, or some other portal, to update the value of positions on a weekly, monthly or quarterly basis. The PFM may also update these positions automatically based on data acquired from one or more financial services. The PFM may provide a rich graphical representation of complex financial models to enable understanding of one's financial status, e.g., cash flow, at a glance. The PFM may provide financial statements (profit and loss, balance sheet, cash flow) across multiple financial and business entities owned by a user, to assist the user to comprehensively manage all the entities contributing to the user's total net worth.

Thus, the PFM is optionally capable of tracking multiple classes of assets in order to report a total net worth. The PFM preferably goes beyond traditional financial reporting tools in that it also calculates the value of assets more complex than cash accounts and market assets. For example, the PFM may track the value of a business, including operating and non-operating LLCs and other types of entities. The PFM may also track the value of complex business entities across multiple geographical and organizational levels, providing a rich graphical representation of financial status as well as financial statements at every level and category of the complex business entity that is selected by the user.

### Document Management

In some embodiments, the dashboard 300 includes an entry point for a document manger, or an interface to a remotely hosted document management system. The document manager may be a highly secure file server where all documentation is stored for an individual and the individual's assets, including personal files, legal documents, tax documents, property documents, insurance documents, asset descriptions, financial investment due diligence and valuation documents, permits, registrations, manuals, and the like. The document manager interface may include a search tool to enable quick location of documents.

### Media Management

In some embodiments, the dashboard 300 includes an entry point 302 for a media management module. The media management module may store, or provide an interface for accessing a server storing, personal photos, movies, music, and the like. The media management module may enable a user to upload content to a media library and to access media stored in the library. The media management module may include image management software to enable the organization and accessing of photographs. The media management module may include video and/or audio players for playback of media stored in a media library.

### Communications Management

In some embodiments, the dashboard 300 includes an entry point for a communications module that manages one or more of contacts, calendaring, tasks, email, VoIP and other messaging applications. The communications module may interface with a server such as a Microsoft Exchange server, or the like. The communications module may interface with networking tools such as video conferencing (e.g., Skype), SMS networking (e.g., Twitter), and the like. The communications module may include a message center for a voice over IP (VOIP) system that provide call logs, voice message retrieval, editing of account settings, forwarding features, and the like. The communications module may integrate with, for example, the Cisco Unified Communications Manager software for IP telephony features integration.

### Widgets and Services

The dashboard 300 may also include entry points 302 for various helpful applications such as calculators, sticky notes, tax locale trackers, alarm clocks, and the like. The dashboard 300 may also include entry points 302 for various helpful services such as streaming of digital rights management-protected content, genealogical searches, games, and the like.

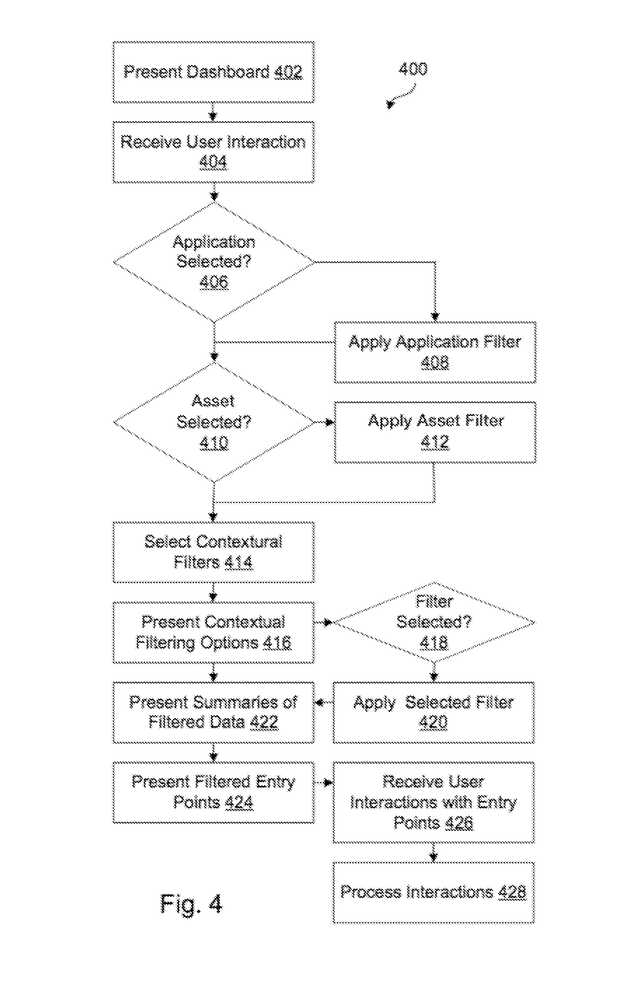

FIG. 4 illustrates an embodiment of a method 400 of operation of a PLM dashboard 300 in accordance with an embodiment of the present invention. A dashboard 300 may be displayed 402 to a user. The dashboard 300 may include initial summary data 304 and operation entry points 306 corresponding to the status of one or more properties and a user's preferences or a previous state of the PLM application. User interaction with the dashboard 300 may then be received 404. User interaction may include selection by the user of one or more of an application entry point 302a-302f, an asset entry point 308a-308f, and a contextual application filter 310a-310d. User interaction may also include user selection of an operation entry point 306 from a previously displayed or default set of operation entry points 306 displayed on the dashboard 300. If the user selection is found 406 to be an application entry point 302a-302f, then a filter in accordance with the selected application entry point is applied 408. This may include presenting summaries of data reflecting the status of aspects of one or more assets that can be manipulated using the application associated with the selected application entry point 408. Alternatively, this may include displaying data or data summaries relating to data displayed or operated upon by the application associated with the selected entry point 302a-302f. Applying 408 a filter may also include selecting operation entry points 306 for display corresponding to the functionality of the selected application entry point 302a-302b.

The method 400 may include evaluating 410 whether an asset entry point 308a-308f has been selected. If so, then an asset filter is applied 412 to the data 304, operation 306, and notification 312 entry points displayed. As noted above, this may include limiting the data 304 selected for display in the dashboard 300 to data relevant to the selected asset entry point 308a-308f, which may be a class or category of assets. Likewise, the operation entry points 306 and notification entry points 312 selected for display may be limited to those that are operable to view or alter the status of assets corresponding to the selected asset entry point 308a-308f.

The method 400 may also include selecting 414 one or more contextual filters according to any selected application entry point 302a-302f and/or asset entry points 308a-308f. The selected contextual filters 310a-310d may be displayed 416, such as in the configuration illustrated in FIG. 3. The method 400 may include evaluating 418 whether a contextual filter has been selected. If so, then the selected contextual filter may be applied 420 to determine the data 304, operation 306, and notification entry points 312 selected for display.

Summaries of the data 304 selected according to any of the selected filters, or complete representations of the filtered data, may be presented 422 to a user, such as illustrated in FIG. 3. Likewise, operation entry points 306 filtered as described herein may be presented 424. User interaction with the data 304 and/or entry points 306 may then be received 426 and processed 428. This may include performing actions at remote properties as described herein, displaying additional information, updating a database, or any other computerized or automated operation as known in the art of property, asset, or data management. Processing 428 may include updating the dashboard 300 to display additional or fewer data or additional or fewer operation entry points 306.

The illustrated dashboard 300 and method 400 are particular advantageous for ultra-high net worth (UHNW) individuals. Applications that facilitate management of an individual's personal and professional life are displayed as application entry points 302a-302f. Likewise, means to access specific real properties, categories of real properties, assets, and categories of assets are listed as asset entry points 306a-306f. The 3rd dimension of the contextual filters 310a-310d make it quick and easy to search, find, and analyze large amounts of complex data quickly and easily.

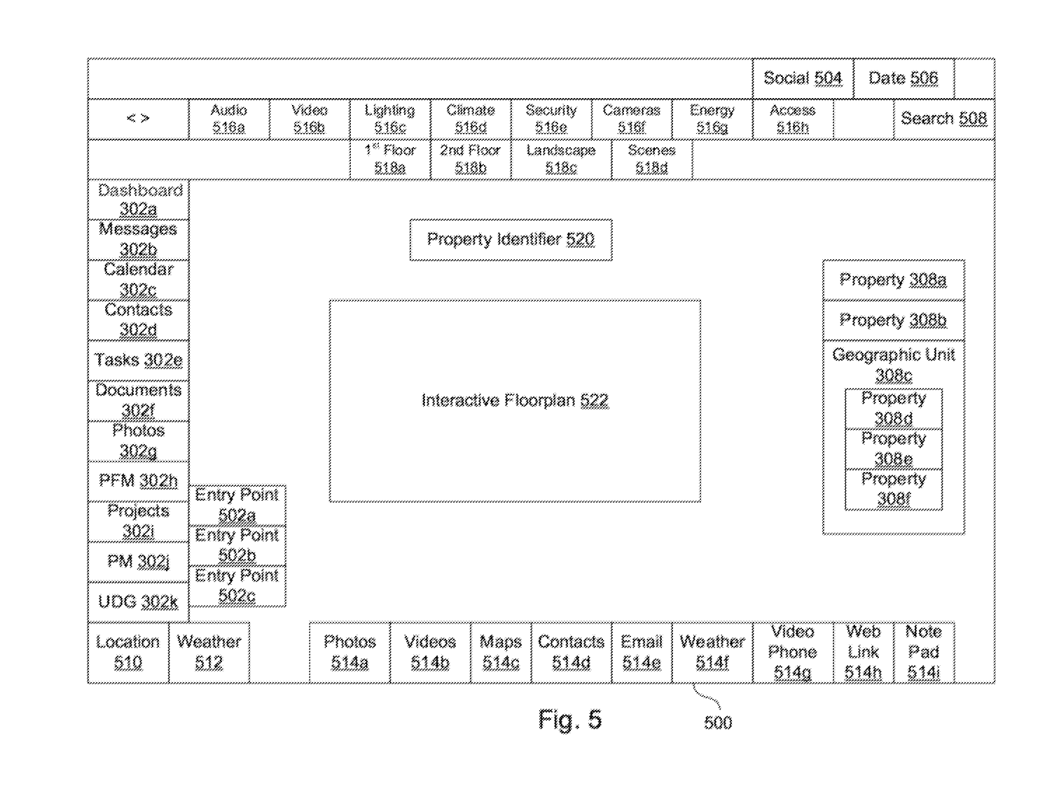

FIG. 5 illustrates an example interface 500 to a PLM application such as described hereinabove. As noted above, a user may interact with the interface 500 on a computing device 210 that is remote from the control system 204. The interface 500 may include application entry points 302a-302k as described herein with respect to the dashboard 300 as described hereinabove. The interface 500 may also include entry points 308a-308f to select any one of a plurality of properties. As noted above, the entry points 308a-308f may include an entry point 308c for a category or class of properties. Entry points 308d-308f for individual properties within the category may be listed upon selection of the category entry point 308c.

As shown in FIG. 5, entry points 302a-302k are provided as for the dashboard 300. The entry points 302a-302k may be coupled to applications for managing or monitoring various properties. For example, the entry points 302a-302k may be linked to applications for viewing messages (e.g., email, instant messaging, text, etc.), a calendar application, a contacts database, a task list, a document manager, a photo database, a personal financial management (PFM) application, a project management application, a property management (PM) application, and a user designated grouping (UDG) of applications. These applications may be linked to information relating to properties. For example, a messaging application may receive messages from automated monitoring equipment or personnel managing a property. A calendaring application may list the scheduled occupancy dates for a property, scheduled maintenance activities, property tax due dates, and the like. Likewise, task, document, project, and photo applications may be used to access, generate, and otherwise manage tasks, documents, projects, and photos relating to various properties. Any and all of the application entry points 302a-302k may also invoke applications operating on data that is not tied to a specific property.

A UDG entry point may include any and all of the applications shown as well as any that a user may select to install or include in a group. Upon selection of the UDG entry point 302k, a user may be presented with selectable entry points 502a-502c for the applications within the UDG. Likewise, selection of an application, such as the property management entry point 302j may result in the display of entry points for specific property management applications.

In the illustrated embodiment, the application interface 500 may include one or more entry points 504 selectable by a user to connect to one or more social networking sites or related applications, such as Facebook, Twitter, and the like. The interface 500 may also display an indicator 506 of the data and/or time. The indicator 506 may also include other time sensitive information such as breaking news and news feeds. A search entry point 508 may be provided that enables a user to enter key words and invoke a search of data accessible by the PLM application.

The interface 500 may also include a location indicator 510 that may also function as an entry point for geographically related information. The location indicator 510 may be set to display a user's current location and one or more items 512 of local information, such as the temperature, weather conditions, and the like. Selection of the location indicator 510 may invoke the display of other geographically related information or entry points for geographically related applications, such as for obtaining tickets for local events, reservation for local restaurants, obtaining directions, and the like. Selection of the location indicator 510 may present an interface for a user to change the location associated with the location indicator and to change the items 512 of local information.

The PLM may include entry points 514a-514i for applications that are not necessarily property related but that are useful in enabling an individual to manage information and life activities. For example, entry points may be included in the interface 500 for a photo accessing and archiving application, video accessing and archiving application, map viewing application, contact database application, email access application, weather information application, video phone application (e.g. Skype), web browser application, and a notepad application. Entry points for other helpful applications may also be included.

The particular arrangements of the application entry points 302a-302k, asset entry points 308a-308f (real properties in this case), and other application entry points 514a-514i may vary. In the illustrated embodiment, each group of entry points may occupy a different position in the interface 500, but leaves a central area of the interface 500 available for display of contextual information and interface elements.

Upon selection of a property/asset entry point 308a-308f, entry points 516a-516h for various control systems or for manipulating or viewing aspects of the property may be displayed. As illustrated, entry points may be provided for controlling audio, video, lighting, climate, security, cameras, and other home automation and monitoring systems known in the art. Entry points for applications monitoring or controlling energy usage and for controlling access to the property may also be displayed. Entry points 518a-518d may be displayed corresponding to subsystems or areas of the selected property, such a floor, outbuilding, or exterior region. In a portion of the interface, such as a central area of the interface 500 a property identifier 520 indicating the selected property may be displayed. Upon selection of one of the entry points 518a-518d an interactive floorplan 522 of the corresponding subsystem or area may be displayed with interface elements and data summaries corresponding thereto.

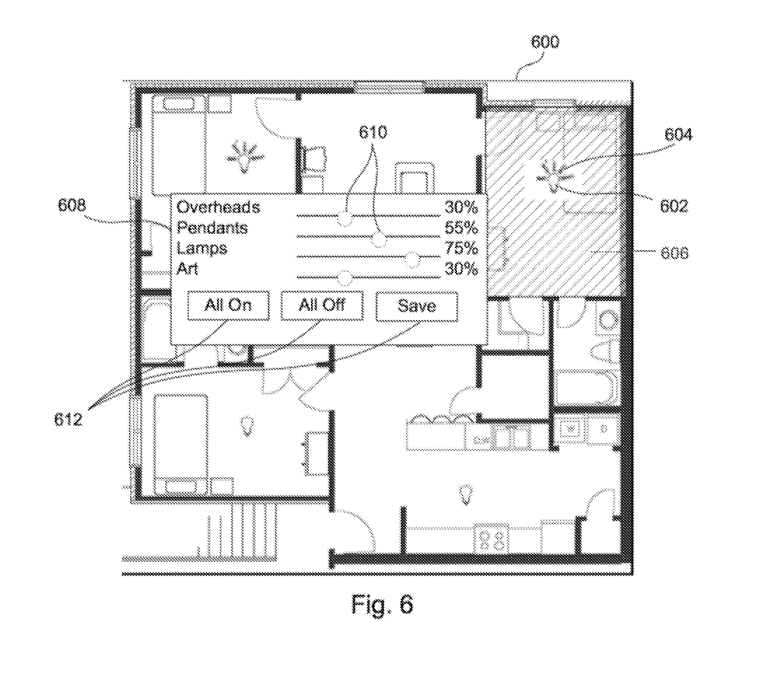

FIG. 6 illustrates an interactive floorplan 600 corresponding to a lighting control system such as may be accessed remotely using a PLM application as described herein. The illustrated interactive floorplan 600 may be displayed in the context of the interface 500 or dashboard 300, such as in the place of the interactive floorplan 522 of FIG. 5 or as the data 304 of the dashboard 300. As is apparent in FIG. 6, the floorplan 600 includes component controls 602 illustrated as light bulbs. The component controls 602 may include status indicators 604 indicating the status of the component controlled by the component control 602. In the example of FIG. 6, the status indicator 604 indicates whether some or all of the lights in a room are turned on.

Upon selection of a component control 602 an area 606 of the floorplan 600 affected by the component control 602 may be highlighted and a menu 608 displayed. The menu 608 displays one or more interface element for changing the status of the component corresponding to the component control 602. One or more indicators of the status of the component may also be displayed on the menu 608. In the illustrated embodiment, the interface elements may include sliders 610 for variable intensity lighting and/or buttons 612 for turning some or all of the lights in a space on or off, saving a lighting configuration, selecting a saved configuration, or performing other lighting related functions. In an embodiment, the interactive floorplan can be used to manage and control component controls other than lighting, some of which are described hereinbelow.

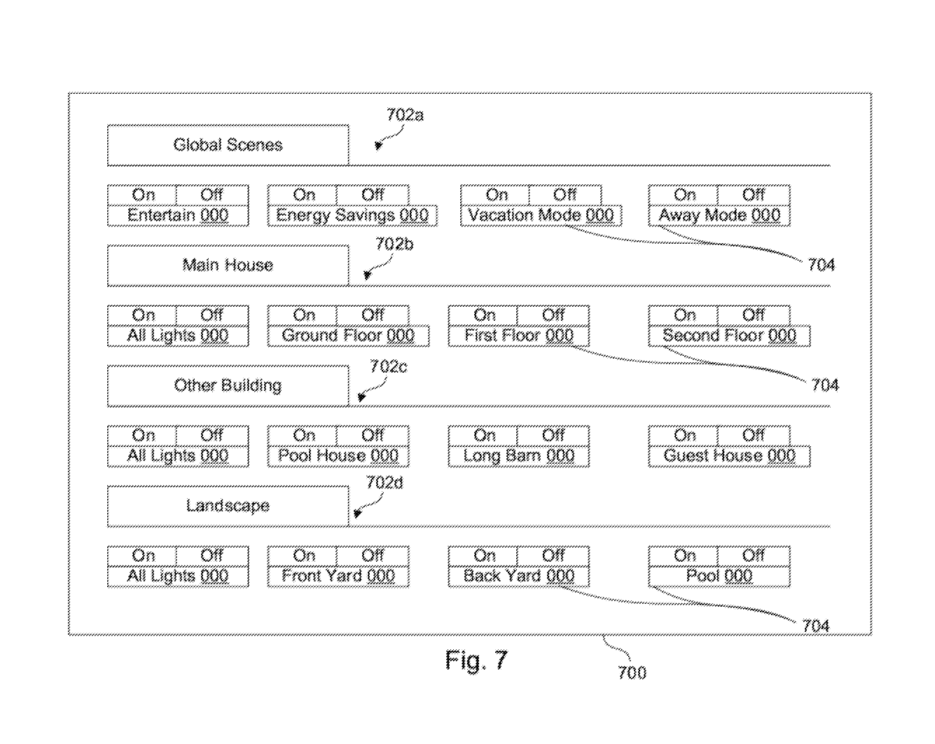

FIG. 7 illustrates an additional or alternative interface 700 for controlling a lighting system. The interface 700 may be presented in response to selection of an entry point, such as the entry point 518d of the interface 500 or an entry point 302a-302f and property 308a-308f of the dashboard 300. In the illustrated interface 700, interfaces elements are presented in logically related groups 702a-702d. For example, a group 702a may include interface elements 704 for changing global scenes for a lighting system, such as entertain, energy savings, vacation, and away lighting modes. Other groups 702a-702d may aggregate controls, or entry points for control interfaces for specific structures or external areas. The interface elements 704 of a group may correspond to individual component controls or to groups of related controls, such as those associated with a floor, outbuilding, or an area of a lawn. In an embodiment, this alternative interface may be used to manage and control component controls other than lighting.

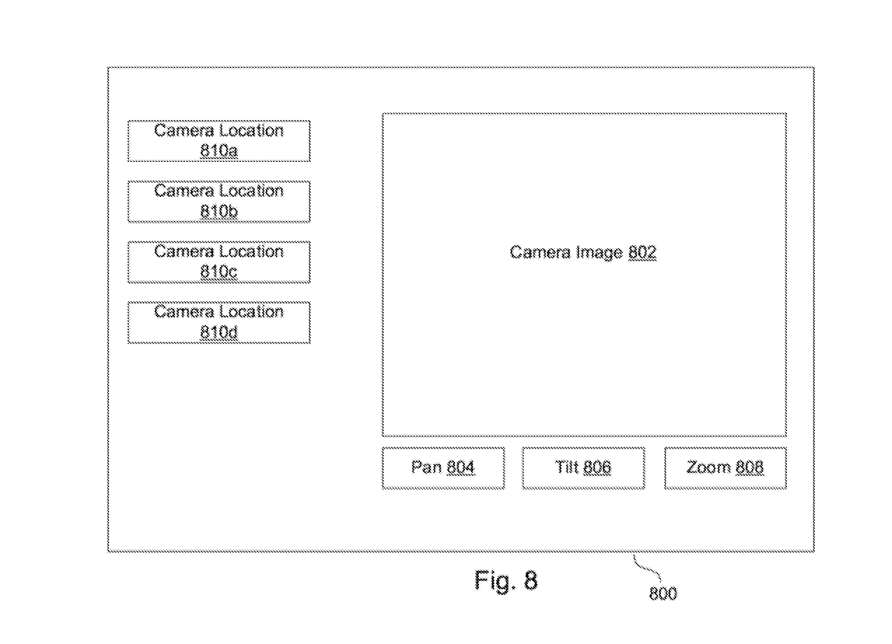

FIG. 8 illustrates an interface 800 to a security camera application. The interface 800 may be presented in the context of a PLM application, such as by displaying the interface 800 in the place of the interactive floorplan 522 of the interface 500 or as the data 304 shown in the dashboard 300. The interface 800 may be presented in response to user selection of an entry point 516f of the interface 500 for the camera system of a selected property or a corresponding entry point 302a-302f and property 308a-308f of the dashboard 300. The interface 800 may display a live or still image 802 output from a surveillance camera. Controls for the camera such as a pan control 804, tilt control 806, and zoom control 808 may also be included for remotely changing the configuration of a camera at a selected property. For properties with multiple cameras, camera selection elements 810a-810d may be included in the interface 800 and be selected by a user to invoke the presentation of the output of a corresponding camera as the live or still image 802.

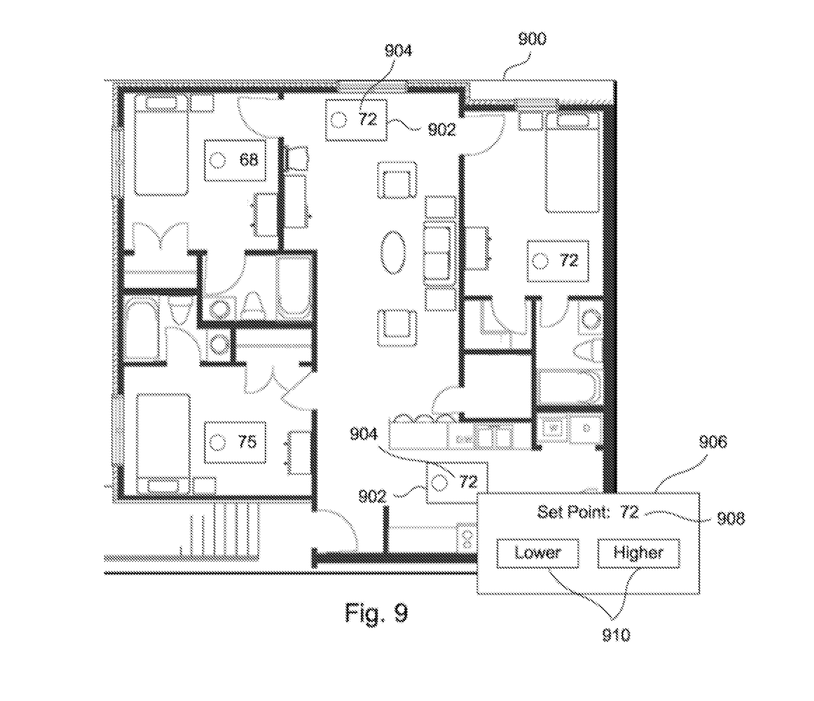

FIG. 9 illustrates an interactive floorplan 900 corresponding to a climate control system such as may be accessed remotely using a PLM application as described herein. The illustrated interactive floorplan 900 may be displayed in the context of the interface 500, such as in the place of the interactive floorplan 522 of FIG. 5 or as the data 304 shown in the dashboard 300. The interface 900 may be presented in response to user selection of an entry point 516d of the interface 500 for the climate control system of a selected property or a corresponding entry point 302a-302f and property 308a-308f of the dashboard 300. As is apparent in FIG. 9, the floorplan 900 includes component controls 902. The component controls 902 may include status indicators 904 indicating the status of the component controlled by the component control 902. In the example of FIG. 9, the status indicator 904 indicates a current temperature and/or set temperature of the room in which it is located.

Upon selection of a component control 902 a menu 906 may be displayed. The menu 906 displays one or more interface element for changing the status of the component corresponding to the component control 902. One or more indicators 908 of the status of the component, such as the current set temperature and/or current actual temperature, may also be displayed on the menu 906. In the illustrated embodiment, the menu includes interface elements 910 enabling a user to instruct a climate control system to increase or decrease the set temperature for a space or to specify an arbitrary temperature. Other controllable aspects of a climate control systems may also be adjusted using the menu 906 such as humidity and airflow.

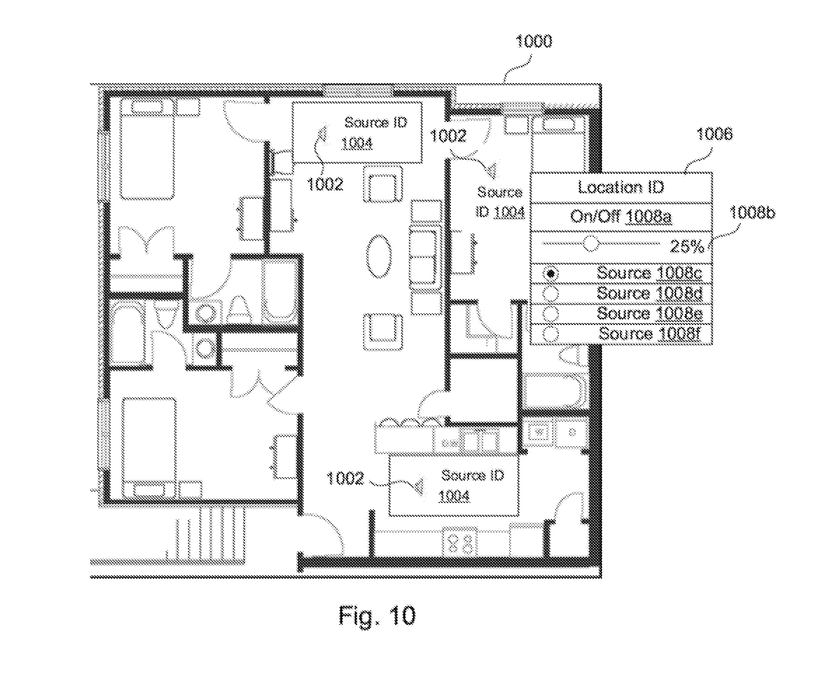

FIG. 10 illustrates an interactive floorplan 1000 corresponding to an audio control system such as may be accessed remotely using a PLM application as described herein. The illustrated interactive floorplan 1000 may be displayed in the context of the interface 500, such as in the place of the interactive floorplan 522 of FIG. 5 or the data 304 displayed in the dashboard 300. The interface 1000 may be presented in response to user selection of an entry point 516a of the interface 500 for the climate control system of a selected property or a corresponding entry point 302a-302f and property 308a-308f of the dashboard 300. As is apparent in FIG. 10, the floorplan 1000 includes component controls 1002. The component controls 1002 may include status indicators 1004 indicating the status of the component controlled by the component control 1002. In the example of FIG. 10, the status indicator 1004 indicates the source of content being played on an audio system located at a given location on the floorplan 1000. In some embodiments, the status indicator 1004 indicates a volume of the content being played.

Upon selection of a component control 1002 a menu 1006 may be displayed. The menu 1006 displays one or more interface element for changing the status of the component corresponding to the component control 1002. In the illustrated embodiment, the menu includes one or more interface elements 1008a enabling a user to instruct an audio system to turn the audio system on or off, one or more interface element 1008b enabling a user to instruct an audio system increase or decrease a volume of sound being broadcast through an audio component, and one or more interface elements 1008c-1008f enabling a user to select a source of audio content broadcast on the audio system. Possible sources include digitally stored audio files, broadcast radio, CDs, streaming of digital rights management-protected content, and the like. The interactive floorplan of FIG. 10 may also be suitable for a video control system in which the possible sources for content are video sources and the component being controlled is a television or other audiovisual device.

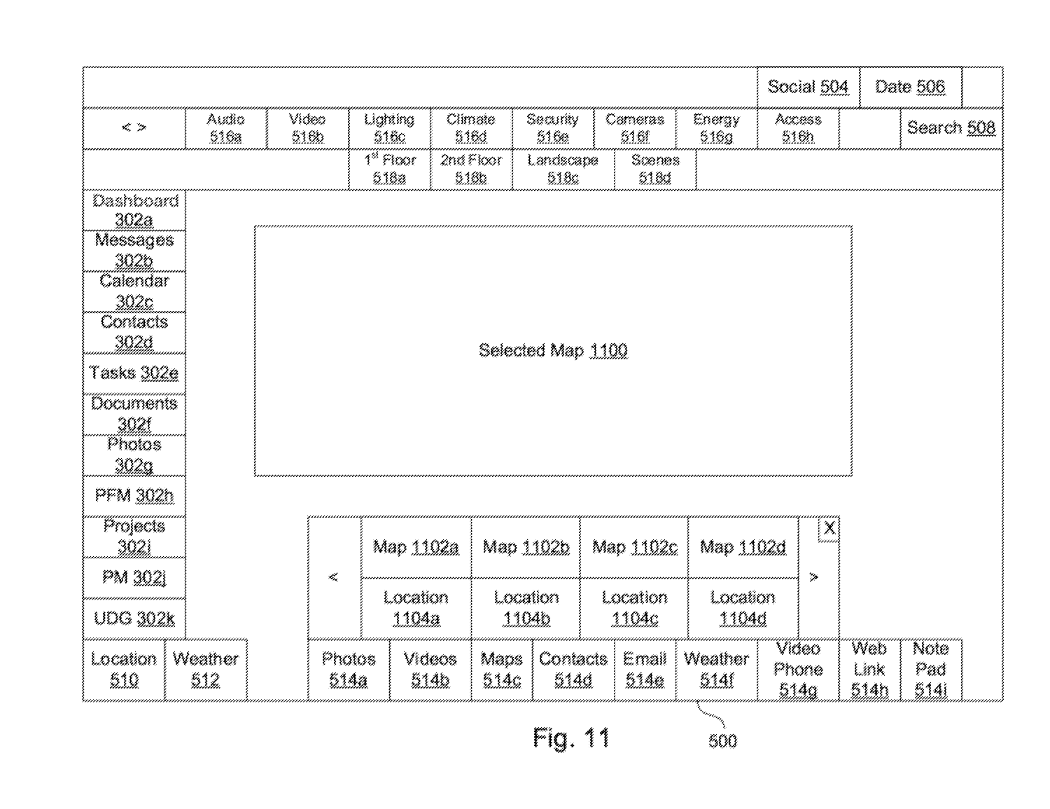

FIG. 11 illustrates an example of a map application executed in the context of the PLM interface 500 or dashboard 300. The illustrated interface may be displayed in response to user selection of an entry point 514c or entry point 302a-302f corresponding to a map application. A selected map 1100 may be presented in a central area of the interface 500 or dashboard 300. An array of map thumbnails 1102a-1102d with corresponding text identifiers 1104a-1104d may be displayed. The maps presented may correspond to properties associated with the properties managed using the PLM application interface 500. Upon selection of a map 1102a-1102d, a larger image 1100 of that map may then be displayed. The map may be displayed as a satellite image, road map, or superposition of both, depending upon a user preference. Other maps not corresponding to properties managed using the interface 500 may also be searchable and displayable using the illustrated application as known in the art of map applications. The map application may enable a user to request directions and other cartographical functions as known in the art of maps and navigation.

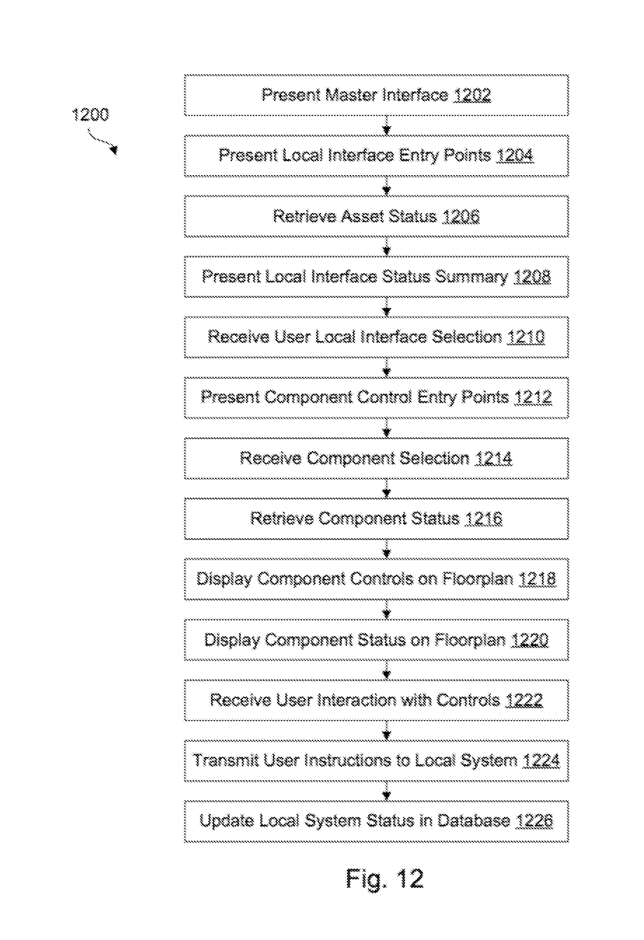

FIG. 12 illustrates a method 1200 for managing distributed properties 202a-202c and other tangible and intangible assets. A master interface is presented 1202 to a user; this may include presenting 1204 entry points to specific local interfaces or interfaces for managing particular assets. The master interface may have some or all of the attributes of the dashboard 300 or PLM interface 500 described hereinabove. The master interface may provide access to other interfaces for specific properties or classes of properties. The status of various assets may be retrieved 1206 and a summary of the status may be presented 1208 adjacent entry points corresponding to those assets. A user selection of a local interface entry point from the master interface may be received 1210. Upon receiving the user's selection, user may be presented 1212 with additional entry points for interfaces to specific components of the local interface. Those additional entry points can be in the form of a drop-down menu or an additional menu bar on the top, bottom or side of the application framework.

A user selection of a specific component entry point may be received 1214. In response the status of the selected components may be retrieved 1216. One or both of controls for the selected component and the status of the selected component may then be displayed 1218, 1220, such as in the context of a floorplan as described hereinabove. User interaction with the controls may then be received 1222. Upon receiving a user interaction, instructions corresponding to the user interactions may be transmitted 1224 to the local control system for execution. This may include transmitting instructions from a remote user computing device 210 to a control system 204. The status of the component affected by the user instructions may then be updated 1226 in a database. The database may be co-located with the control system 204, user computing device 210, or at some other location accessible by means of the network 208.

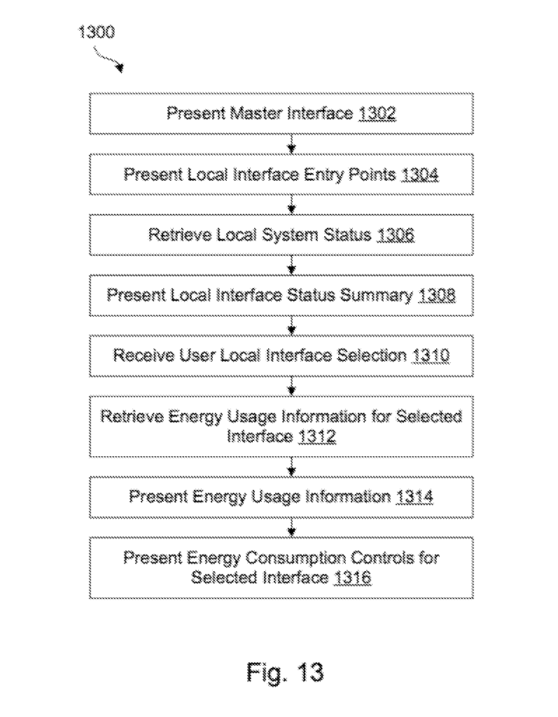

FIG. 13 illustrates a method 1300 for managing energy usage of a plurality of remote properties. A master interface may be presented 1302 to a user. The master interface may have some or all of the attributes described hereinabove with respect to the dashboard 300 or PLM interface 500 described herein. Entry points to controls of local interfaces for one or more properties, which may be remote, may be presented 1304 to a user. A status of the properties corresponding to the local interfaces may be retrieved 1306 and presented 1308, such as adjacent the interface entry points. A user selection of a specific local interface to a property 202, which may be remote, may be received 1310. Energy usage information for the property 202 of the selected local interface may be retrieved 1312. This may include retrieving usage statistics for a specific period such as a week, month, or year. The usage information may be presented 1314 as part of the interface. Controls for energy consuming components such as a lighting system or climate control system may also be presented 1316. In some embodiments, the controls presented at step 1316 may include presenting options for energy saving settings or modes of operation. Upon selection of these options, instructions for implementing energy saving settings or modes of operations may then be transmitted to the local controls system 204 corresponding to the selected interface. The control system 204 may then instruct components to change their state or mode of operation in response to the received instructions.

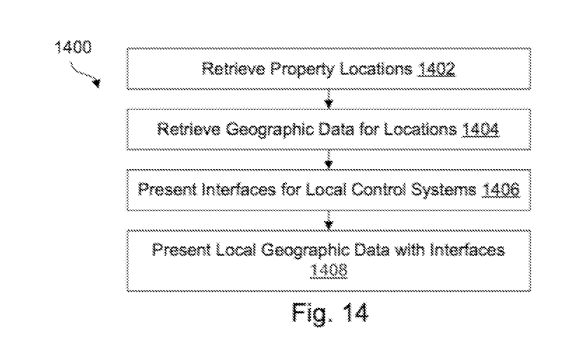

FIG. 14 illustrates a method 1400 for relating geographic data to a remotely presented interface to a local control system 204. The geographic locations of properties controlled by a remote interface may be retrieved 1402. Geographic data relating to the property locations may also be retrieved 1404 according to proximity of the subjects of the geographic data to the properties. The geographic data may include weather data in the proximity of a property, tides, snow conditions and depth, local entertainments events, satellite images, local alerts, and other geographically referenced data. An interface, or entry point to an interface, to the control system 204 of a remote property may then be presented 1406 and the geographic data may also be presented 1408 adjacent the interface for the property to which it corresponds. Entry points for geographic application functions may also be presented, such as applications for finding directions on a map, booking local reservations or tickets, viewing local news and cultural events, and the like.

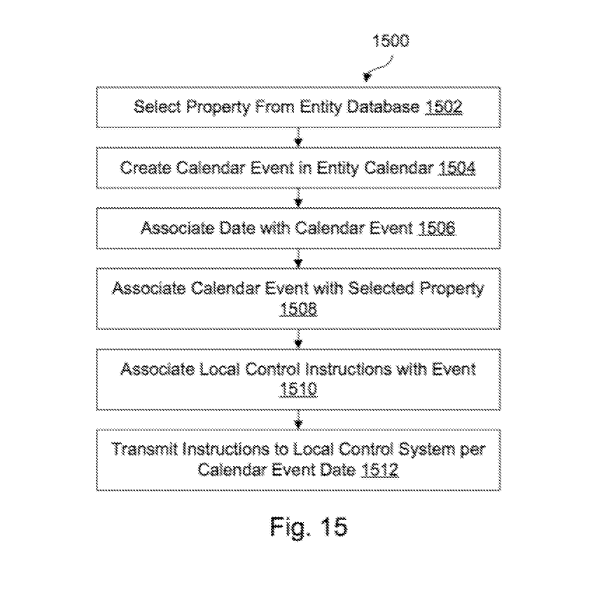

FIG. 15 illustrates a method 1500 for integrating a property management interface with a calendaring application. A property 202 may be selected 1502 from a database of properties associated with an owning or controlling entity. A calendar event may be created 1504 in a calendar associated with the entity. A date and/or time may be associated 1506 with the calendar event and the calendar event may be associated 1508 with the selected property. A local control instruction may also be associated 1510 with the calendar event. The instruction may be to unlock the doors, disarm an alarm system, turn on heating or cooling, turn on interior or exterior lighting, heat a pool or spa, or perform some other action to prepare a property for occupancy. The calendaring event may specify when a property is no longer occupied such that the property can be closed up or otherwise prepared for a lack of occupants. Upon arrival of the date and/or time associated with the calendar event, the local control instruction may be transmitted 1512 to the control system 204 of the selected property 202. This method may be used for assets other than real property assets.

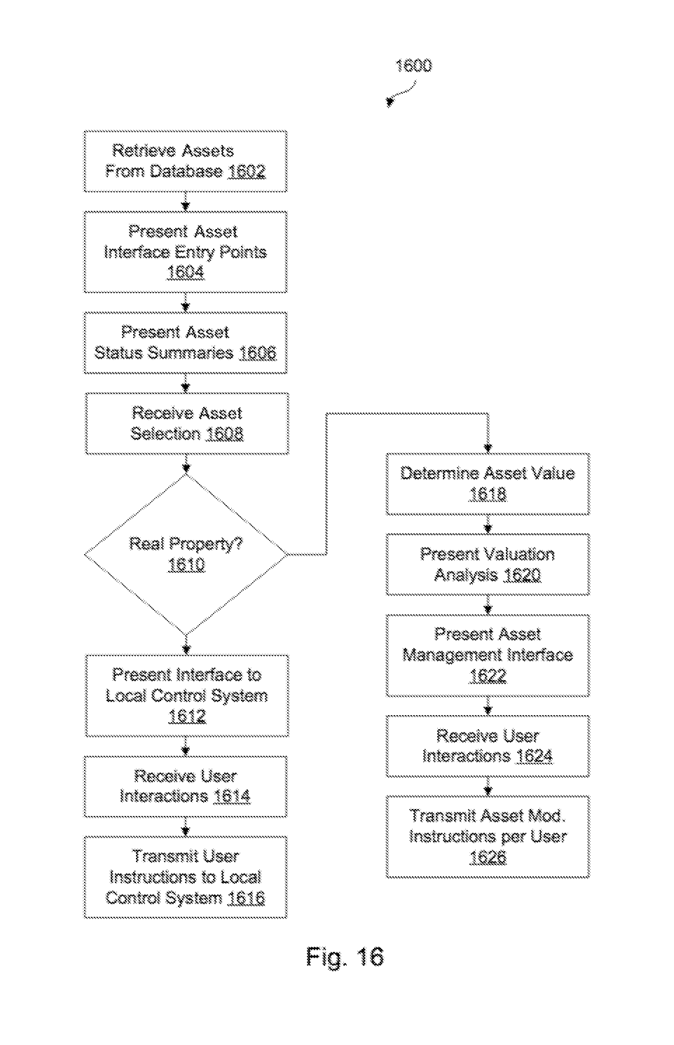

FIG. 16 is a process flow diagram of a method 1600 for managing financial aspects of a plurality of assets owned or controlled by an entity. Records for a plurality of assets may be retrieved 1602 from a database of assets and entry points for interfaces to the assets may be displayed 1604. Asset status summaries 1606 may also be presented. For real properties, the status summaries may include those described hereinabove for components 206 of a property 202a-202c. For financial assets, investments of all types, financial and other accounts, and other intangible properties, the status summary may be a valuation or market value of the asset or a portfolio of like assets.

A selection of a particular asset or category of assets may be received 1608 and the type of the selected asset may be evaluated 1610. If the selected property is a real property having a control system 204, then processing may continue as described hereinabove. For example, an interface to a local control system 204 for the selected property 202 may be presented 1612 and user interaction with the interface may be received 1614 and transmitted 1616 to the local control system 204 as described hereinabove. A valuation of the property may also be presented according to market data and parameters describing the property.

If the property is found 1610 to be other than a real property, such as a cash account, bond fund, stock, or some other financial or intangible asset, then the asset value may be determined 1618, or retrieved 1618 if previously calculated. For some types of assets, valuation may be complex. Accordingly, the step of determining a property's value may include embedding sophisticated valuation algorithms and consulting market data. The value of the property may then be presented 1620. Presenting 1620 the value of the asset may include presenting historical valuations as well as a present value. Comparisons to one or more benchmarks or other components of an owning or controlling entity's portfolio may also be displayed. The presentation 1620 of the value may include one or more of a cash flow analysis of one or more assets, performance evaluation of one or more of the plurality of assets, a current market value of one or more of the plurality of assets, and a portfolio analysis of some or all of a plurality of assets.

In some embodiments, an asset management interface may be presented 1622 and user interactions with the interface may be received 1624. The user interactions may include asset management operations such as buying, selling, or otherwise modifying an owning entity's interest in an asset. Instructions corresponding to the user's interactions with the assets may then be transmitted to a financial institution or other entity for fulfillment of the user's instructions.

The asset management interface may also be operable to present summaries of an individual's financial condition such as an estimated total value of all assets for which the PLM has data available to evaluate, including real property, financial assets, investments of all types, financial and other accounts, businesses, and other tangible and intangible property that may have a value assigned thereto. The asset management interface may also be operable to retrieve data relating to the individual's financial condition from a variety of financial systems and services 214 and from databases 216 that are securely coupled to the systems and services.

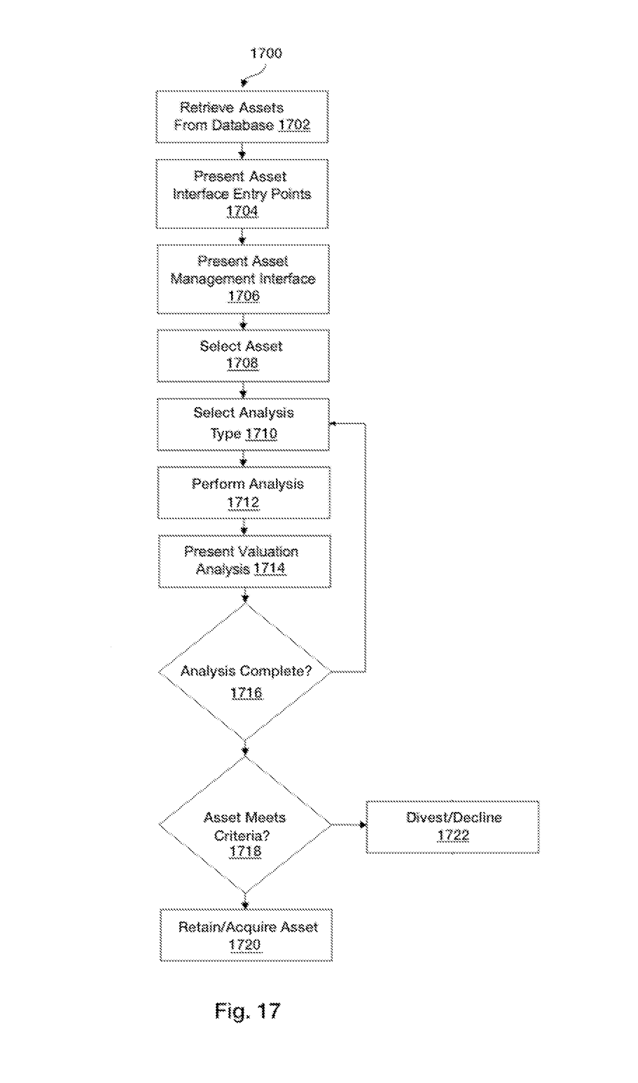

FIG. 17 is a process flow diagram of a method 1700 for managing valuations for a plurality of financial assets owned or controlled by an entity. Records for a plurality of assets may be retrieved 1702 from a database of assets and entry points for interfaces to the assets may be displayed 1704, along with the asset management interface 1706. The user may select an asset 1708 and then select an analysis type 1710. At this point, processing may continue and the selected analysis 1710 may be performed 1712, which may result in a newly determined asset value 1714 based on the parameters and type of the analysis 1710. In some embodiments there may be an evaluation to determine whether the analysis is complete 1716. If the evaluation 1716 indicates that the analysis may not be complete, the user may select a different analysis type 1710, then may perform a new analysis 1712 which may result in the presentation of a newly determined asset valuation 1714. If the evaluation 1716 indicates that the analysis is complete, there may be an evaluation 1718 to determine whether the asset meets certain criteria. If the evaluation 1718 indicates that the asset meets certain criteria, the asset 1720 may be acquired or retained. If the asset does not meet certain criteria, action 1722 may be taken to decline or divest the asset.

In some embodiments, the asset management interface 1706 may also be operable to evaluate and present detailed analyses of investment type assets 1708 and to follow those investment type assets through analysis 1712 and presentation of the analysis 1714 prior to purchase; analysis 1712 of valuation and details of the analysis presented 1714, relating to the performance of the investment during the time it is held; and analysis 1712 of valuation and details presented 1714 relating to the sale or divesture of the investment. Details of the analysis 1712 of declined investments may also be presented 1714. Investments may include but are not limited to direct investments, venture capital investments, private equity investments, indirect investments, fund investments, loans, real estate, and other real assets such as art, precious metals, rare coins, antiques, and so forth. The types of investments and the parameters available for each type may be configurable, enabling a user to employ the preferred decision methodologies specific to that user's analytical processes.

In some embodiments, the asset management interface 1706 may also be operable to provide financial and financial modeling analysis 1712 capabilities and presentation of analysis results 1714 for investment type assets. These capabilities may be tailored to the status as well as the type of the investment. These capabilities may also include financial projections, scenario analysis, projected valuation analysis, return analysis, budget vs. actual analysis, budgeting and analysis of operating expenditures, budgeting and analysis of capital expenditures, capitalization analysis, asset allocation analysis, liquidity analysis, budget and transaction analysis, real-time forecasting, competitive analysis, and the like.

In some embodiments, the asset management interface 1706 may also be operable to provide analysis 1712 and presentation of information 1714 regarding business operations that are owned by the user. Information available may include financial statements such as balance sheets, income statements, profit and loss statements, cash flow, and the like. Information presented 1714 may also include results of advanced analytical and modeling tools similar to those described hereinabove.

In some embodiments, the asset management interface 1706 may also be operable to perform analyses of the effects of market indicators on a user's financial portfolio performance, and to present the result of these analyses 1714. The market indicators may include historical performance information for the assets in the user's portfolio. Market indicators may also include global and national economic indicators including but not limited to gross domestic product for the nation where the investment is located, market indices, commodity prices, currencies and exchange rates, a variety of interest rates, work force participation rates, unemployment rates, and the like. These indicators may be used to perform predictive analysis for the user's portfolio performance; such predictive analysis may include hypothetical scenario generation, definition, analysis, and the like.

In some embodiments, the asset management interface 1706 may also be operable to perform analyses of the use of assets as philanthropic gifts. Assets may be retrieved from the database 1702, and asset interface entry points 1704 and the asset management interface may be presented 1706. An asset 1708 and an analysis type 1710 may be selected and the analysis 1712 may then be performed. Results of the analysis 1714 are presented to the user. The user may then determine whether the analysis is complete 1716. If the analysis is complete, the user may then determine whether the philanthropic gift of an asset meets set criteria 1718. If the philanthropic gift of an asset meets the set criteria, the gift of the asset proceeds 1720; if the philanthropic gift does not meet the set criteria, the gift is not made (declined) 1722.

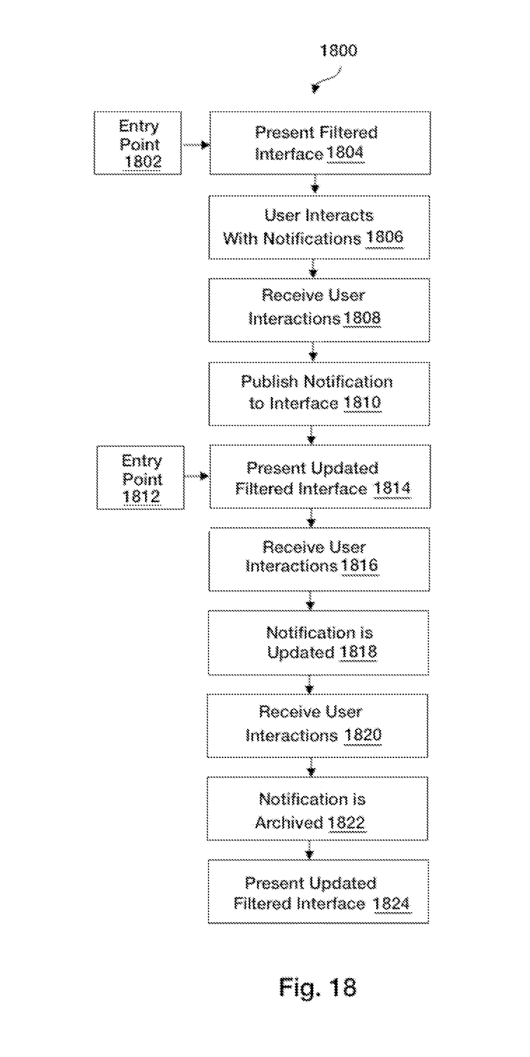

FIG. 18 illustrates a method 1800 for creating and managing notifications. Notifications as described hereinabove may be used as a mechanism for the communication of information about property and financial assets being managed, monitored and evaluated. Notifications may be created on any specific item of information tracked, and can take various forms including alerts, notes, conversations, approvals, and the like. Notifications may also embed a reminder, tickler notice, or the like. Notifications may be defined so as to communicate to specific team members, to all team members, or to maintain information for the creator of the notification. There is an entry point 1802. A filtered interface 1804 is presented to the user. The user identifies a notification to add and interacts with notifications 1806. The user interaction is received and the notification is transmitted to the database 1808. The notification is then published to the dashboard interface of defined recipients of the notification 1810. A second entry point 1812 is present. An updated filtered interface 1814 is presented to a user who is defined as a recipient for the notification created by the first user. The user interacts with the notification 1816. This interaction may take the form of reading the notification or specifically dismissing the notification, which results in the notification being updated 1818. The notification can receive further interactions 1820. These interactions may include adding comments to the notification creator or other recipients, adding files, approving a request, or dismissing the notification from the recipient user's interface 1820. Eventually the user interactions 1820 result in the notification being archived 1822. When the notification is archived, an updated filtered interface is presented 1824.

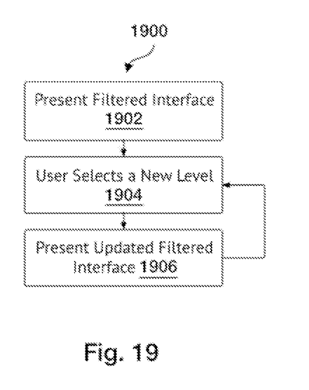

FIG. 19 illustrates a method 1900 for navigating financial information in a complex investment or business entity. A complex investment or business entity may include multiple levels of sub-entities and other categorizations such as geographical categorizations. A filtered interface 1902 is presented to the user. The user can select a new level of sub-entities or other categories 1904. When the selection is made, an updated version of the filtered interface 1906 is presented. The user can continue to select different levels and categorizations. The user can drill up or down methodically, or make selections that jump between levels and other categorizations. For example, if the complex business entity included operations in the United States and Europe as well as multiple levels of business entities from individual properties and related businesses, the user could select an individual property 1904 in the United States, view the filtered interface for that property 1906, then select a holding entity in Europe that was comprised of properties and businesses in multiple countries 1904, then view the filtered interface for that holding entity 1906.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention, this is used for transitive and non-transitive storage. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state during transitive and non-transitive storage. The invention is not limited to any particular type of memory device, or any commonly used protocol for storing and retrieving information to and from these memory devices, respectively.

The elements of the PLM application described above could be utilized to manage other aspects including but not limited to management of hotels, staff, aviation, yachts, small businesses and trusts and estates.

In an embodiment, a hotel management application provides owners and managers of hotels with all the necessary management tools to efficiently oversee a hospitality business. Such tools include but are not limited to budgeting programs, accounting programs, occupancy projection programs, checklists for maintenance and daily operational tasks that can be monitored remotely, KPI analysis functions, and a booking calendar.

In another embodiment, a staff management application provides owners and managers with a human resources tool to efficiently oversee employees in properties all over the world. Such employees may be in service in businesses, on real estate properties, on yachts, or in any other capacity. The staff management application tracks and stores work hours, compensation, employee status, employee personal information, work records, visas, permits, performance reviews and all other information related to the effective management of staff in individual locations and across multiple locations.

In yet another embodiment, an aviation management application provides owners and managers with an asset management tool to efficiently operate fixed wing and rotary wing aircraft. The aviation management application tracks and stores all relevant information related to the ownership, maintenance and operating issues associated with aircraft. Such information includes, but is not limited to, the aircraft's purchase price, value, operating hours, maintenance schedules, ticklers for additional maintenance, crew information, insurance documents, and more.

In an embodiment, a yacht management application provides owners and managers with an asset management tool to efficiently operate sail and motor yachts. The yacht management application tracks and stores all relevant information related to the ownership, maintenance and operating issues associated with yachts. Such information includes, but is not limited to, the yacht's purchase price, value, operating hours, maintenance schedules, ticklers for additional maintenance, crew information, insurance documents, and more.

In another embodiment, a small business management application provides owners and managers of small businesses with all the necessary management tools to efficiently oversee the growth and management of a business. Such tools include but are not limited to, budgeting programs, accounting programs, strategic planning programs, project management tools, marketing plan templates, KPI analysis functions, and more.

In yet another embodiment, a trust and estate management application provides owners and financial advisors with all the necessary management tools to efficiently oversee an individual's financial assets and estate planning. The trust and estate management application stores all critical documents such as the last will and testament and trust formation agreements. It further provides individuals and financial planners with templates and tools for developing all the documents and procedures needed for proper succession planning and wealth transfer between generations and/or with foundations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for managing asset information and control comprising:
providing a database identifying a plurality of assets;
providing a plurality of local control systems, each local control system associated with a respective asset;
providing, on a workstation operably coupled to the database and remote from the plurality of assets, an interface associated with each asset;
associating each interface of each asset with a respective local control system associated with the asset;
receiving, on the workstation, a user selection of an interface associated with an asset of the plurality of assets;
receiving, on the workstation, user interaction with the selected interface;
communicating a control signal between the interface and the local control system associated with the interface in accordance with the received user interaction; and
controlling the respective asset with the respective local control system using the received control signal.

2. The method of claim 1, wherein the database includes a floorplan for at least one of the plurality of assets; and
wherein the interface for the at least one asset includes user controls corresponding to the local control system associated therewith superimposed on a display of the floorplan of the at least one interface.

3. The method of claim 1, wherein the local control system includes one or more of:
a lighting control system, a climate control system, a surveillance control system, an audio control system, a video control system, a pool and spa control system, an access control system, a security control system, a shading control system, other sensor-based control systems, and the like.

4. The method of claim 1, further comprising, for at least one of the plurality of assets:
retrieving geographic data associated the asset according to proximity of a subject of the geographic data to the asset; and
presenting the geographic data adjacent the interface associated with the asset.

5. The method of claim 4, wherein the geographic data is local weather information.

6. The method of claim 4, wherein the geographic data is local surveillance video.

7. The method of claim 4, wherein the geographic data is local entertainment information.

8. A system for managing asset information comprising:
a database identifying a plurality of assets;
a plurality of local control systems, each for controlling a respective asset;
a computing device operably coupled to the database and remote from the plurality of assets, the computing device programmed to:
associate an interface with each asset with the respective local control system associated with the asset;
receive a user selection of an interface associated with an asset of the plurality of assets;
present the selected interface;
receive user interaction with the selected interface; and
communicate a control signal between the selected interface and the respective local control system associated with the interface in accordance with the received user interaction;
wherein the respective local control system controls the respective asset using the received control signal.

9. The system of claim 8, wherein the database includes a floorplan for at least one asset of the plurality of assets; and
wherein the interface for the at least one asset includes user controls corresponding to the local control system associated therewith superimposed on the floorplan.

10. The system of claim 8, wherein the interface associated with each system includes an interface for one or more of a lighting control system, a climate control system, a surveillance control system, an audio control system, a security control system, a shading control system, other sensor-based control systems, and the like.

11. The system of claim 8, wherein the computing is further programmed to, for at least one of the plurality of assets:
retrieve geographic data associated the asset according to proximity of a subject of the geographic data to the asset; and
present the geographic data adjacent the interface associated with the asset.

12. The system of claim 11, wherein the geographic data is local weather information.

13. The system of claim 11, wherein the geographic data is local surveillance video.

14. The system of claim 11, wherein the geographic data is local entertainment information.

15. A computer program product for managing assets, the computer program product comprising a non-transitory, computer-readable storage medium having computer-usable program code embodied therein, the computer-usable program code causing a processor, for a plurality of assets each having a local control system, to:
access a database listing the plurality of assets, each controlled by a respective local control system;
provide an interface to the local control system of each asset of the plurality of assets, the interface being executed on a computer system remote from the plurality of local control systems;
receive a user selection of an interface associated with an asset of the plurality of assets;
receive user interaction with the selected interface;
communicating a control signal between the selected interface and the local control system corresponding thereto in accordance with the received user interaction; and
controlling the respective asset of the respective local control system using the received control signal.

16. The computer program product of claim 15, wherein the database includes a floorplan for at least one of the plurality of assets; and
wherein the interface for the at least one asset includes user controls corresponding to the local control system associated therewith superimposed on a display of the floorplan of the at least one asset.

17. The computer program product of claim 15, wherein the interface to the local control system of an asset of the plurality of assets includes an interface to one or more of a lighting control system, a climate control system, a surveillance control system, an audio control system, a security control system, a shading control system, other sensor-based control systems, and the like.

18. The computer program product of claim 15, wherein the computer-usable program code is further configured to, for at least one asset of the plurality of assets:
retrieve geographic data associated the at least one asset according to proximity of a subject of the geographic data to the asset; and
present the geographic data adjacent the interface associated with the at least one asset.

19. The computer program product of claim 18, wherein the geographic data is local weather information.

20. The computer program product of claim 18, wherein the geographic data is local entertainment information.

21. An asset management system comprising:
a database identifying a plurality of assets associated with an entity, the assets including one or more of real property, personal property, a tangible asset, an intangible asset, and a financial asset;
a plurality of local control systems each co-located with an asset of the plurality of assets and configured to control aspects the asset;
an interface executed on a computing device remote from the plurality of assets, the interface having a plurality of control elements and being configured to communicate user inputs as control signals to the local control systems, the interface further programmed to aggregate monetary value information for at least a portion of the plurality of assets and present the aggregated monetary value information;
wherein the respective local control system controls the respective asset using the received control signal.

22. The asset management system of claim 21, wherein the assets include real property.

23. The asset management system of claim 21, wherein the interface includes a master interface including a plurality of entry points for asset interfaces for individual assets of the plurality of assets; and
wherein the master interface is further configured to retrieve status information from the asset interfaces of the plurality of assets and display the status information adjacent the plurality of entry points.

24. The asset management system of claim 21, wherein the interface is further programmed to include a calendaring function configured to:
receive calendaring information; and
remotely invoke the one or more local control systems according to the calendaring information.

25. The asset management system of claim 21, wherein the plurality of assets include financial assets and the interface is further programmed to provide a financial asset interface configured to, for each intangible asset:
indicate a value of the asset; and
receive user instructions with respect to the intangible assets and transmit the user instructions to a processing system for execution.

26. The asset management system of claim 21, wherein the aggregated monetary value information includes one or more of:
cash flow analysis of one or more of the plurality of assets;
performance evaluation of one or more of the plurality of assets;
current market value of one or more of the plurality of assets; and
portfolio analysis of some or all of the plurality of assets.

27. A method for performing asset management comprising:
presenting, on a user computer, application entry points each operable to invoke an application operable to remotely manipulate an aspect of one or more assets remote from the user computer;
presenting, on the user computer, asset filters each associated with an asset or category of assets;
receiving, on the user computer, a user selection of one or both of an application entry point and asset filter;
presenting on the user computer, one or more data summaries according to one or both of the application and asset filter included in the user selection;
communicating a control signal to one or more assets; and
remotely manipulating the respective aspect of one or more assets remote from the user computer.

28. The method of claim 27, further comprising:
presenting, on the user computer, one or more operation controls selected according to the user selection, the operation controls operable to cause changing of the status of one or more of the assets; and
receiving user interaction with the one or more operation controls.

29. The method of claim 28, further comprising:
presenting, on the user computer, contextual filter controls, the contextual filter controls selected according to the user selection;
performing, on the user computer, one or both of adding data summaries and removing data summaries according to any user interaction with one of the contextual filter controls.

30. The method of claim 29, further comprising performing, on the user computer, one or both of adding operation controls and removing operation controls according to any user interaction with one of the contextual filter controls.

31. The method of claim 27, wherein each asset filter of the asset filters references one of an individual asset and a category of assets.

32. The method of claim 31, wherein the category of assets is one of a geographic region and an asset type.

33. The method of claim 32, wherein the asset type is one of tangible and intangible asset.
